(19) United States
(12) Patent Application Publication
(10) Pub. No.: US 2025/0204538 A1
(43) Pub. Date: Jun. 26, 2025

(54) TOPICAL DECORATION OF DOUGH PRODUCTS

(71) Applicant: General Mills, Inc., Minneapolis, MN (US)

(72) Inventors: Mark E. Arlinghaus, Minneapolis, MN (US); Madison Auld, Maple Grove, MN (US); Keegan Withey, St. Louis Park, MN (US); Aaron P. Wlaschin, St. Paul, MN (US); Louis W. Woehrmann, Woodbury, MN (US)

(73) Assignee: General Mills, Inc., Minneapolis, MN (US)

(21) Appl. No.: 18/973,400

(22) Filed: Dec. 9, 2024

Related U.S. Application Data
(60) Provisional application No. 63/613,865, filed on Dec. 22, 2023.

(51) Int. Cl. A21D 6/00; A21D 10/02; A21D 13/31

(52) U.S. Cl. CPC A21D 6/00; A21D 10/02; A21D 13/31

(57) ABSTRACT

A method of commercial mass producing a dough product having a desired design formed thereon comprises directing a rope of dough along a conveyor, the rope of dough including an outer surface, creating a series of distorted initial designs upon successive regions of the outer surface of the rope and reshaping (e.g., cutting or crimping) the rope into individual food pieces. The initial designs created upon the dough rope are distorted in relation to the desired final designs. An individual food piece formed by the reshaping includes a periphery within which at least one of the distorted designs is transformed into the desired design by the reshaping.

### CROSS-REFERENCE TO RELATED APPLICATION

This application claims the benefit of and priority to U.S. Application No. 63/613,865, filed Dec. 22, 2023, which is incorporated herein by reference.

### FIELD OF THE INVENTION

The invention generally pertains to the commercial, mass production of dough products and, more particularly, to producing dough products, such as pizza rolls, with designs formed thereon.

### BACKGROUND OF THE INVENTION

Pizza rolls are a popular type of dough product and typically have a filling that contains a sauce and particulates (e.g., meat pieces, cheese pieces, veggies, etc.). Existing pizza rolls and similar dough products, while providing a convenience enjoyed by many consumers, lack visual appeal. Printing or otherwise forming an edible design on food bases is known during manufacturing of various food products. In the case of food products which are significantly reshaped during production, printing or otherwise forming a design on the food during manufacturing is limited to latter production stages, i.e., after any reshaping/distortion steps, which can be inefficient. A challenge exists with providing topical decoration to dough products efficiently and without undesirable distortion during production.

### SUMMARY OF THE INVENTION

A method of commercial mass producing a dough product of the present invention having a desired design formed thereon comprises directing a rope of dough along a conveyor, the rope of dough including an outer surface. In some embodiments, the rope of dough is a rope of filled dough including an inner filling material and an outer dough shell. In some embodiments, the rope of filled dough is formed by co-extruding the outer dough shell and the inner filling material. The method further includes creating a series of distorted initial designs upon successive regions of the outer surface of the rope before reshaping (e.g., cutting and/or crimping) the rope into individual food pieces. In some embodiments, creating the series of distorted initial designs includes inkjet printing or laser printing the series of distorted initial designs. The initial designs created upon the dough rope are distorted in relation to the desired final designs (“distorted initial designs”). The parameters of the initial designs created depend upon the size of the rope, the size and shape of the individual dough products to be formed and the type/orientation of the reshaping performed (e.g., cut or crimped perpendicular or diagonal to the direction of the rope conveyance). An individual food piece formed by the reshaping includes a periphery within which at least one of the distorted designs is transformed into the desired design by the reshaping.

A dough product of the present invention having a desired design formed thereon comprises an individual piece of a rope of dough, the individual piece including an outer surface having a periphery, and the desired design upon the outer surface within the periphery. In some embodiments, the individual piece includes an inner filling material and an outer dough shell. In some embodiments, the periphery is at least partially defined by a cut or a crimped edge. In some embodiments, the individual piece is rectangular, square, triangular or spherical in shape. In some embodiments, the rope has a width, and the individual piece has a length smaller than the width of the rope.

### BRIEF DESCRIPTION OF THE DRAWINGS

FIG. 1 shows a decorated dough product having an undesired design on its outer surface.

FIG. 2 shows a decorated dough product made in accordance with the invention and having a desired design on its outer surface.

FIG. 3 is a cross-sectional view of the dough product of FIG. 2.

FIG. 4 is schematic view of a production assembly used to produce decorated filled dough products in accordance with the present invention.

### DETAILED DESCRIPTION OF EMBODIMENTS

Initially, it should be noted that the embodiments of the present invention described below are not intended to be exhaustive or limit the invention to the precise forms disclosed in the following detailed description. Rather, a purpose of the embodiments chosen and described is so that the appreciation and understanding by others skilled in the art of the principles and practices of the present invention can be facilitated.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

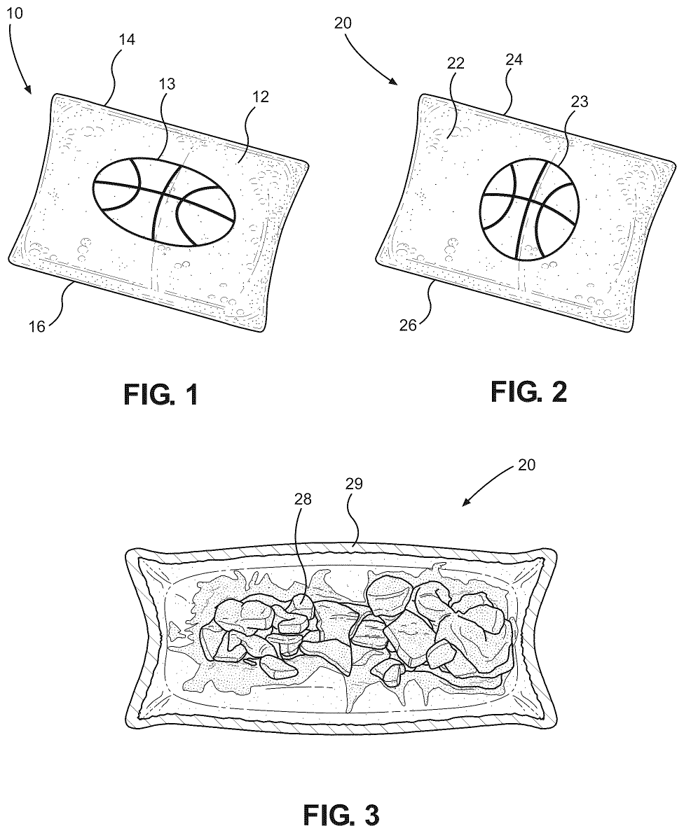

Some dough products are produced by forming a rope and then reshaping (e.g., cutting, crimping and/or otherwise separating into pieces) the rope to form individual dough pieces (e.g., dough balls) which can then be cooked (e.g., fried). Printing (e.g., inkjet printing or laser printing) or otherwise forming an edible design (e.g., image, pattern, picture) upon the rope after it is formed does not present much of a problem despite the domed surface of the rope. However, upon cutting/crimping or otherwise reshaping the filled rope, the initially formed design distorts (e.g., flattens) along with the distortion of the dough. See, e.g., in FIG. 1 an individual dough piece 10 having upon its upper surface 12 a distorted, undesired final design 13. In particular, FIG. 1 illustrates a rectangular dough piece 10 having a final design 13 of a basketball outline that has shortened in height undesirably so as to appear oblong, compared to its initial formed design of round a basketball outline, in a direction perpendicular to the piece's cut/crimped edges (top and bottom edges 14 and 16, respectively). The present inventors have discovered that distortion of the initially formed design upon cutting/crimping/reshaping of the rope can be compensated by adjusting the initially formed design such that the distortion instead results in a desired final design (corrected relative to the initially formed design). See, e.g., in FIG. 2 an individual dough piece 20 mass produced in accordance with the present invention having upon its upper surface 22 a desired final design 23 (a round basketball outline) despite undergoing crimping/cutting to form top and bottom edges 24 and 26, respectively. Edges 24 and 26 help define the periphery of upper surface 22 in which desired design 23 is located. FIG. 3 is a cross-section of dough piece 20 which is a filled dough piece and illustrates an inner filling material 28 and outer dough shell 29.

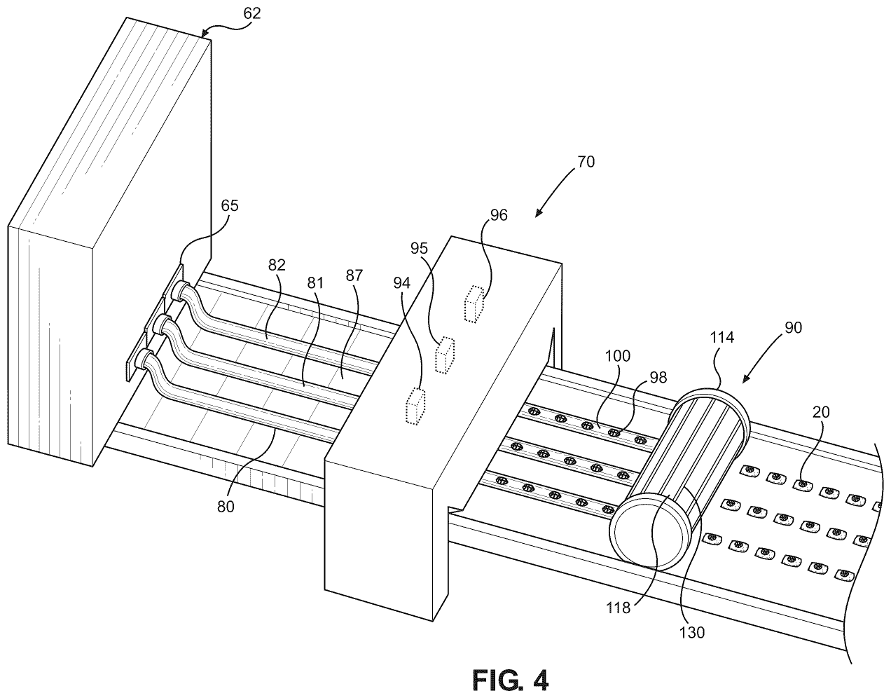

A method of commercial mass producing a dough product of the present invention having a desired design formed thereon comprises directing a rope of dough having an outer surface (e.g., an upper surface, a bottom surface or a side surface) along a conveyor. In some embodiments, the rope is a rope of filled dough including an inner filling material and an outer dough shell. In some embodiments, the rope of filled dough is formed by co-extruding the outer dough shell and the inner filling material. See, e.g., FIG. 4 which illustrates a multi-row extruder 62 having a plurality of laterally spaced heads, one of which is indicated at 65, forming a plurality of elongated, laterally spaced rows of food product which are deposited, in the form of continuous ropes 80-82, onto a common conveyor 87.

The method of producing a dough product having a desired design formed thereon further includes creating a series of distorted initial designs upon successive regions of the outer surface (e.g., an upper surface, a bottom surface or a side surface) of ropes 80-82 prior to actually establishing individual food products. In some embodiments, each rope 80-82 is directed through a printing assembly (see, e.g., a printing assembly 70 in FIG. 4). In some embodiments, the printing assembly is a laser printing assembly or an inkjet printing assembly. The printing assembly can include a number of longitudinally spaced print heads (e.g., print heads 94-96) positioned directly above a travel path of a respective rope (e.g., ropes 80-82). With this arrangement, as each rope 80-82 is directed through printing assembly 70, print heads 94-96 are successively activated through a controller (not shown) to print a design upon the respective rope. More specifically, using strip 82 as an example, print head 96 represents a print head configured to print a series of distorted initial designs (e.g., design 98) on an upper surface 100 of strip 82. Each of the ropes is continuously moving such that each rope 80-82 is continually printed at successive regions (e.g., longitudinally adjacent sections) as clearly shown in FIG. 4. In some embodiments, creating the series of distorted initial designs includes laser printing or inkjet printing the series of distorted initial designs.

The initial designs created upon the dough rope are distorted in relation to the desired final designs (“distorted initial designs”). The parameters of the initial designs created depend upon the size of the rope, the size and shape of the individual dough products to be formed and the type/orientation of the reshaping performed (e.g., cut or crimped perpendicular or diagonal to the direction of the rope conveyance). In some embodiments, the initial designs, compared to the desired final designs, are intentionally stretched in a direction perpendicular to the reshaping directionality (e.g., perpendicular to a cut or crimped edge to be formed). The act of reshaping (described below) the dough rope transforms the initial designs into the desired final designs.

The method of producing a dough product having a desired design formed thereon further includes reshaping the rope into individual food pieces. In some embodiments, the reshaping includes cutting and/or crimping. The size and shape of the individual food pieces reshaped from the rope of dough can vary. In some embodiments, the individual food pieces formed can be rectangular, square, triangular or spherical (e.g., cut by an iris cutter or a scroll cutter) in shape. For example, the food piece of FIG. 2 is rectangular in shape. In some embodiments, reshaping the rope includes using an iris cutter: the rope is forced through a cutter that opens and closes similar to the iris of a photographic camera. In these embodiments, the size and shape (e.g., spherical) of the individual food pieces can be varied by varying the speed of opening or closing the iris cutter. As shown in FIG. 4, in some embodiments, ropes 80-82 are led to a cutting or crimping assembly 90 extending across conveyor 87. In some embodiments, assembly 90 includes a roller 114 having an outer surface 118 from which project a plurality of laterally extending and circumferentially spaced crimping or cutting members, one of which is indicated at 130. As ropes 80-82 are directed beneath crimping or cutting assembly 90, individual dough products 20 are continuously produced through a pinching or severing operation.

In some embodiments, the rope 80-82 of dough is directed along the conveyor 87 in a first direction and reshaping the rope 80-82 includes cutting or crimping the rope 80-82 in a second direction. The second direction can be non-parallel to the first direction and even perpendicular to the first direction. The second direction can be non-parallel and non-perpendicular to the first direction (i.e., diagonal). In some embodiments, the rope 80-82 has a width and reshaping the rope 80-82 includes reshaping the rope 80-82 into individual food pieces having a length smaller than the width of the rope. At this point, it should be noted that the above-described production stages could be performed manually but, more preferably, are part of a mass production process. Certainly, if mass produced, even more than three product lines could be established using conveyor 87. In some embodiments, the method further includes freezing or refrigerating the individual food pieces.

An individual food piece formed by the reshaping includes a periphery within which at least one of the distorted designs is transformed into the desired design by the reshaping. Contrast, e.g., exemplary individual dough piece 20 of FIG. 2 with individual dough piece 10 of FIG. 1. In some embodiments, the topically decorated individual dough pieces are cooked (e.g., fried).

A dough product of the present invention having a desired design formed thereon, comprises an individual piece of a rope of dough, the individual piece including an outer surface (e.g., an upper surface, a bottom surface or a side surface) having a periphery, and the desired design upon the outer surface within the periphery. See, e.g., individual dough piece 20 of FIG. 2 and its related description above. In some embodiments, the individual piece includes an inner filling material and an outer dough shell. See, e.g., FIG. 3. In some embodiments, the periphery is at least partially defined by a cut or crimped edge. In some embodiments, the individual piece is rectangular, square, triangular or spherical in shape. In some embodiments, the rope has a width, and the individual piece has a length smaller than the width of the rope. In some embodiments, the dough product is a refrigerated filled dough product or is a frozen dough product.

Although described with respect to various embodiments of the invention, it should be understood that various changes and/or modifications can be made without departing from the invention. Importantly, the invention is directed to the commercial, mass production of dough products wherein the distorted designs are created on an intermediate product such that, after further processing of the product, the product is reshaped to establish desired, non-distorted designs from the distorted designs. As the initial shaping, design-forming and re-shaping is uniform in the commercial setting, mass production of such products with final undistorted designs is enabled.

1. A method of mass producing a dough product having a desired design formed thereon, the method comprising:
directing a rope of dough along a conveyor, the rope of dough including an outer surface;
creating a series of distorted initial designs upon successive regions of the outer surface of the rope; and
after creating the series of distorted initial designs, reshaping the rope into individual food pieces, with each individual food piece including a periphery within which at least one of the distorted initial designs is transformed into the desired final design by the reshaping.

2. The method of claim 1, wherein creating the series of distorted initial designs includes inkjet printing or laser printing the series of distorted initial designs.

3. The method of claim 1, wherein reshaping the rope includes cutting or crimping the rope.

4. The method of claim 3, wherein the rope of filled dough is directed along the conveyor in a first direction and cutting or crimping the rope includes cutting or crimping the rope in a second direction, the second direction being non-parallel to the first direction.

5. The method of claim 4, wherein the second direction is perpendicular to the first direction.

6. The method of claim 4, wherein the second direction is non-perpendicular to the first direction.

7. The method of claim 3, wherein cutting or crimping the rope includes cutting the rope with an iris cutter.

8. The method of claim 1, wherein reshaping the rope includes reshaping the rope into individual food pieces that are rectangular, square, triangular or spherical in shape.

9. The method of claim 1, wherein the rope has a width and reshaping the rope includes reshaping the rope into individual food pieces having a length smaller than the width of the rope.

10. The method of claim 1, wherein the rope of dough is a rope of filled dough including an inner filling material and an outer dough shell.

11. A dough product having a desired design formed thereon, produced by the method of claim 1.
